(19) United States
(12) Patent Application Publication
(10) Pub. No.: US 2009/0162488 A1
(43) Pub. Date: Jun. 25, 2009

(54) BEVERAGE PRODUCTS AND FLAVOR SYSTEMS HAVING A NON-SWEETENING AMOUNT OF MONATIN

(75) Inventors: Zena Bell, Hartsdale, NY (US); Thomas Lee, Scarsdale, NY (US); Larissa Goble, Beacon, NY (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: The Concentrate Manufacturing Company of Ireland, Hamilton (BM)

(21) Appl. No.: 12/334,937

(22) Filed: Dec. 15, 2008

Related U.S. Application Data
(63) Continuation-in-part of application No. 11/962,258, filed on Dec. 21, 2007.

(51) Int. Cl. A23L 2/56; A23L 2/00; A23L 2/60; A23L 2/68

(52) U.S. Cl. 426/72; 426/537; 426/590

(57) ABSTRACT

Beverage products and flavor systems including a non-sweetening amount of monatin are provided. Beverage concentrate compositions including a non-sweetening amount of monatin are also provided. In addition, methods for making beverages are provided comprising the steps of providing said flavor system, providing at least one additional beverage ingredient, and mixing the flavor system in an amount of 0.01% to 5.0% by weight of the full strength beverage with the at least one additional beverage ingredient to form a full strength beverage.

### PRIORITY CLAIM

This application is a Continuation in Part of co-pending prior application U.S. Ser. No. 11/962,258, filed on Dec. 21, 2007, entitled, “Beverage Having a Non-Sweetening Amount of a Potent Natural Sweetener,” the entire disclosure of which is herein incorporated by reference.

### TECHNICAL FIELD

This invention relates to beverages and other beverage products, such as beverage concentrates, etc. In particular, this invention relates to beverages and other beverage products having formulations suitable to meet market demand for alternative nutritional characteristics, taste characteristics and/or mouthfeel characteristics.

### BACKGROUND

Improved and new formulations for beverages are desirable to meet changing market demands. In particular, there is perceived market demand for beverages having alternative flavor profiles, including good taste, mouthfeel, etc. There is perceived market demand for beverage products having alternative taste characteristics, including, for example, accentuation of flavor impact.

It is therefore an object of the present invention to provide beverage products suitable to meet market demand for alternative flavor profiles and/or mouthfeel characteristics in beverage products, or for alternative formulations for certain flavor profiles or taste characteristics. These and other objects, features and advantages of the invention or of certain embodiments of the invention will be apparent to those skilled in the art from the following disclosure and description of exemplary embodiments.

### SUMMARY

It has been discovered that a non-sweetening amount of monatin can modify the taste of flavor systems and beverage products, causing an increase in desirable taste characteristics such as, for example, one or more of accentuation of flavor impact, flavor enhancement, improvement of sweetness temporal effect, addition of quick sweetness onset, and/or improved mouthfeel. It has also been discovered that a non-sweetening amount of monatin can cause a decrease in undesirable taste characteristics in beverage products such as, for example, bitterness, sourness, off-flavor or off-notes, sweetness linger, aftertaste, or any combination thereof. It has also been discovered that a non-sweetening amount of monatin can cause a decrease in undesirable mouthfeel characteristics in beverage products such as, for example, oiliness, sliminess, cling, chalkiness, lack of body, or any combination thereof.

In accordance with a first aspect, a beverage is provided comprising water, a non-sweetening amount of the potent natural sweetener monatin, and one or more additional beverage product ingredients. The one or more additional beverage product ingredients may comprise a sweetening amount of at least one sweetener other than monatin, a flavorant, a colorant, an acidulant, a vitamin, a mineral, or a mixture of any of them. The non-sweetening amount of monatin in the beverage is greater than zero and less than 3.0 ppm, and is effective as a taste modifier in the beverage. The sweetening amount of at least one sweetener other than monatin comprises at least one of an additional potent natural sweetener, a potent artificial sweetener, a nutritive natural sweetener, a non-nutritive natural sweetener other than monatin, and a mixture of any of them. Certain exemplary (i.e., non-limiting) embodiments of the beverages disclosed here, wherein a non-sweetening amount of monatin is included as a taste modifier, include carbonated beverages, non-carbonated beverages, cola beverages, tea beverages, etc.

In certain exemplary embodiments, the beverage product is a cola beverage wherein the additional beverage ingredients comprise a sweetening amount of at least one sweetener other than monatin, cola flavor as flavorant, caramel colorant, and acidulant comprising phosphoric acid, citric acid, ascorbic acid, lactic acid, tartaric acid, malic acid, or a mixture of any of them. In certain exemplary embodiments, the beverage product is a tea beverage wherein the additional beverage ingredients comprise a sweetening amount of at least one sweetener other than monatin, at least one of a tea flavor and a tea extract as the flavorant, and at least one of phosphoric acid, citric acid, ascorbic acid, lactic acid, tartaric acid, and malic acid as acidulant.

In accordance with a second aspect, a beverage concentrate is provided comprising an initial volume of water, the potent natural sweetener monatin in an amount that is non-sweetening in a full strength beverage produced by dilution of one part concentrate with five parts water, and one or more additional beverage product ingredient comprising a sweetening amount of a sweetener other than monatin, a flavorant, a colorant, an acidulant, a vitamin, a mineral, or a mixture of any of them. The amount of monatin in the beverage concentrate results in greater than zero and less than 3.0 ppm of monatin in the full strength beverage, and is effective as a taste modifier in the full strength beverage. The sweetening amount of a sweetener other than monatin comprises at least one of an additional potent natural sweetener, a potent artificial sweetener, a nutritive natural sweetener, a non-nutritive natural sweetener other than monatin, and a mixture of any of them. In certain exemplary embodiments, the beverage concentrate is a cola beverage concentrate further comprising an initial volume of water, an acidulant, cola flavor, and caramel color. In certain exemplary embodiments, the beverage concentrate is a tea beverage concentrate further comprising an acidulant, and at least one of a tea flavor and a tea extract.

In accordance with another aspect, a flavor system is provided comprising a solvent, at least one of a flavor extract and an aroma chemical, and the potent natural sweetener comprising monatin in an amount which in a full strength beverage made from the flavor system, wherein the full strength beverage comprises the flavor system in an amount of 0.01% to 5.0% by weight of the full strength beverage, is non-sweetening, is greater than zero and less than 3.0 ppm, and is effective as a taste modifier in the full strength beverage. In certain exemplary embodiments, the solvent includes at least one of water, ethanol, glycerin, propylene glycol, benzyl alcohol, isopropanol, and triacetin. In certain exemplary embodiments, the flavor extract comprises at least one of a cola extract, a tea extract, a berry extract, and a citrus extract.

In accordance with another aspect, a method for making a beverage is provided comprising the steps of providing a flavor system comprising a solvent, least one of a flavor extract and an aroma chemical, and the potent natural sweetener monatin in an amount which is non-sweetening in a full strength beverage comprising the flavor system in an amount of 0.01% to 5.0% by weight of the full strength beverage, providing an additional beverage ingredient comprising at least one of carbonated water, non-carbonated water, a sweetening amount of at least one sweetener other than monatin, a colorant, an acidulant, a vitamin, a mineral, and a mixture of any of them, and mixing the flavor system in an amount of 0.01% to 5.0% by weight of the full strength beverage with the additional beverage ingredient to form the full strength beverage. The amount of monatin in the flavor system results in greater than zero and less than 3.0 ppm of monatin in the full strength beverage, and is effective as a taste modifier in the full strength beverage. The sweetening amount of a sweetener other than monatin comprises at least one of an additional potent natural sweetener, a potent artificial sweetener, a nutritive natural sweetener, a non-nutritive natural sweetener other than rebaudioside A, and a mixture of any of them.

In certain exemplary embodiments, the method is a method for making a cola beverage wherein the flavor extract comprises cola flavor, and the additional beverage ingredient(s) includes carbonated water, the sweetening amount of at least one sweetener other than monatin, caramel color as the colorant, and acidulant comprising at least one of phosphoric acid, citric acid, ascorbic acid, lactic acid, tartaric acid, and malic acid. In certain exemplary embodiments, the method is a method for making a tea beverage wherein the flavor extract comprises tea extract, and the additional beverage ingredient(s) includes non-carbonated water, the sweetening amount of a sweetener other than monatin, and acidulant comprising at least one of phosphoric acid, citric acid, ascorbic acid, lactic acid, tartaric acid, and malic acid.

It will be appreciated by those skilled in the art, given the benefit of the following description of certain exemplary embodiments of the beverage and other beverage products disclosed here, that at least certain embodiments of the invention have improved or alternative formulations suitable to provide desirable taste profiles, nutritional characteristics, etc. These and other aspects, features and advantages of the invention or of certain embodiments of the invention will be further understood by those skilled in the art from the following description of exemplary embodiments.

### DETAILED DESCRIPTION

The present invention provides flavor systems and beverage products having a non-sweetening amount of the potent natural sweetener monatin. It should be understood that flavor systems and beverage products in accordance with this disclosure may have any of numerous different specific formulations or constitutions. The formulation of a flavor system or beverage product in accordance with this disclosure can vary to a certain extent, depending upon such factors as the product's intended market segment, its desired nutritional characteristics, flavor profile and the like. For example, it will generally be an option to add further ingredients to the formulation of a particular flavor system or beverage embodiment, including any of the flavor systems and beverage formulations described below.

As used herein, the term “non-sweetening amount” refers to an amount of sweetener that, in a beverage product as a whole, does not perceptibly increase the sweetness intensity of the beverage product as judged by a majority of persons who have tasted and compared a sample of the beverage product containing the non-sweetening amount of sweetener to a sample of a correspondingly formulated beverage product without the non-sweetening amount of sweetener. In certain exemplary embodiments, the beverage product is not perceptibly sweetened by a low amount of the potent natural sweetener monatin included in the formulation of the beverage product. It should be noted that the sweet taste threshold of any particular sweetener will vary depending on the beverage product formulation in which the sweetener is included. For example, a given amount of a certain sweetener may be noticeably sweet in water, and yet the same amount of the same sweetener may be non-sweetening in a cola beverage formulation. In certain exemplary embodiments, a non-sweetening amount of the potent natural sweetener monatin modifies the taste of the beverage product by increasing one or more desirable taste characteristic, decreasing or eliminating one or more undesirable taste characteristic, decreasing one or more undesirable mouthfeel characteristics, or any combination of these. As used herein, the terms increasing, decreasing, accentuating, and enhancing of a taste or mouthfeel characteristic means perceptibly changing that characteristic in a beverage product compared with the perceptible level of that characteristic in a correspondingly formulated beverage product that does not include a non-sweetening amount of the natural potent sweetener monatin. As used herein, the term “taste modifier” does not include an increase or decrease in sweetness intensity. However, a non-sweetening amount of the potent natural sweetener monatin may provide a synergistic increase in sweetness intensity if blended with a sweetening amount of certain other sweeteners in the beverage product of invention, and such synergism is within the scope of the present invention.

As used herein, the term “taste” refers to the flavor of the beverage product and includes sweetness, sourness, bitterness, saltiness and umami (e.g., savoriness or meatiness). As used herein, the term “mouthfeel” refers to a tactile sensation a beverage product gives to the mouth (i.e., due to physical and chemical interactions in the mouth). Mouthfeel is evaluated from initial perception on the palate through to swallowing. Mouthfeel and taste may overlap and/or impact each other.

As used herein, the term “undesirable taste characteristic” refers to one or more off-flavors that can be perceived in beverage products. Undesirable taste characteristics are known in the art and include, for example, but are not limited to, bitterness, sourness, off-flavor, off-notes, astringency, and any combination thereof.

As used herein, the term “undesirable mouthfeel characteristic” refers to one or more unwanted tactile sensations that can be perceived in beverage products. Undesirable mouthfeel characteristics are known in the art and include, for example, but are not limited to, oiliness, sliminess, cling, chalkiness, lack of body, wateriness, and any combination thereof.

As used herein, the term “desirable taste characteristic” refers to one or more attractive flavors or tastes that can be added to beverage products described here. Desirable taste characteristics are known in the art and include, for example, but are not limited to, one or more of accentuation of flavor impact, flavor enhancement (e.g., flavor perception when eaten), and good sweetness temporal effect (e.g., quick sweetness on-set, no sweetness linger). In certain exemplary embodiments, a non-sweetening amount of a potent natural sweetener reduces or eliminates the need for additional flavor enhancers discussed further herein.

In certain exemplary embodiments the non-sweetening amount of the potent natural sweetener monatin in a beverage product modifies the taste of the beverage product (e.g., a cola beverage, a tea beverage, a beverage concentrate) but does not by itself contribute perceptible sweetness. In certain exemplary embodiments, the beverage product includes a non-sweetening amount of monatin greater than zero and less than 3.0 ppm (e.g., 0.1 ppm to 2.5 ppm, 1.0 ppm to 2.0 ppm, greater than zero and less than 1.0 ppm, 0.2 ppm to 0.5 ppm, greater than zero and less than 0.2 ppm).

The non-sweetening amount of the potent natural sweetener monatin used will depend upon the desired level of taste modification (such as, for example, the degree and amount of increase in desirable taste characteristic(s) and/or flavor perception and/or a decrease in undesirable taste characteristic(s) or undesirable mouthfeel characteristic(s)) for the beverage product. The non-sweetening amount of the potent natural sweetener monatin used will also depend on if the beverage product includes a sweetening amount of a sweetener other than monatin, as monatin may differ in the ability to modify the taste of the beverage product when used in non-sweetening amounts in combination with sweetening amounts of various sweeteners other than monatin.

As used herein, a “potent sweetener” means a sweetener which is at least twice as sweet as sugar, that is, a sweetener which on a weight basis requires no more than half the weight of sugar to achieve an equivalent sweetness. For example, a potent sweetener may require less than one-half the weight of sugar to achieve an equivalent sweetness in a beverage product sweetened to a level of 10 degrees Brix with sugar. Potent sweeteners include both nutritive and non-nutritive sweeteners. In addition, potent sweeteners include both potent natural sweeteners and artificial potent sweeteners. Commonly accepted potency figures for certain potent sweeteners include, for example:

| | | |
|---|---|---|
| Cyclamate | 30 | times as sweet as sugar |
| Glycyrrhizin | 30-50 | times as sweet as sugar |
| Stevioside | 100-250 | times as sweet as sugar |
| Mogroside V | 100-300 | times as sweet as sugar |
| Rebaudioside A | 150-300 | times as sweet as sugar |
| Acesulfame-K | 200 | times as sweet as sugar |
| Aspartame | 200 | times as sweet as sugar |
| Saccharin | 300 | times as sweet as sugar |
| Neohesperidin dihydrochalcone | 300 | times as sweet as sugar |
| Sucralose | 600 | times as sweet as sugar |
| Alitame | 2,000 | times as sweet as sugar |
| Neotame | 8,000 | times as sweet as sugar |

As used herein, the term “nutritive sweetener” refers generally to sweeteners which provide significant caloric content in typical usage amounts, e.g., more than about 5 calories per 8 oz. serving of beverage. As used herein, a “non-nutritive sweetener” is one which does not provide significant caloric content in typical usage amounts, i.e., is one which imparts less than 5 calories per 8 oz. serving of beverage to achieve the sweetness equivalent of 10 Brix of sugar. As used herein, a “full-calorie” beverage formulation is one fully sweetened with a nutritive sweetener. As used herein, “reduced calorie beverage” means a beverage having at least a 25% reduction in calories per 8 oz. serving of beverage as compared to the full calorie version, typically a previously commercialized full-calorie version. As used herein, a “light beverage” means a beverage having at least a one third reduction in calories per 8 oz. serving of beverage as compared to the full calorie version. As used herein, a “low-calorie beverage” has fewer than 40 calories per 8 oz. serving of beverage. As used herein, a “zero-calorie beverage” or “diet beverage” means having less than 5 calories per serving, e.g., per 8 oz. for beverages.

As used herein, the term “natural” is defined in accordance with the following guidelines: Raw materials for a natural ingredient exists or originates in nature. Biological synthesis involving fermentation and enzymes can be employed, but synthesis with chemical reagents is not utilized. Artificial colors, preservatives, and flavors are not considered natural ingredients. Ingredients may be processed or purified through certain specified techniques including at least: physical processes, fermentation, and enzymolysis. Appropriate processes and purification techniques include at least: absorption, adsorption, agglomeration, centrifugation, chopping, cooking (baking, frying, boiling, roasting), cooling, cutting, chromatography, coating, crystallization, digestion, drying (spray, freeze drying, vacuum), evaporation, distillation, electrophoresis, emulsification, encapsulation, extraction, extrusion, filtration, fermentation, grinding, infusion, maceration, microbiological (rennet, enzymes), mixing, peeling, percolation, refrigeration/freezing, squeezing, steeping, washing, heating, mixing, ion exchange, lyophilization, osmose, precipitation, salting out, sublimation, ultrasonic treatment, concentration, flocculation, homogenization, reconstitution, enzymolysis (using enzymes found in nature). Processing aids (currently defined as substances used as manufacturing aids to enhance the appeal or utility of a food component, including clarifying agents, catalysts, flocculants, filter aids, and crystallization inhibitors, etc. See 21 CFR § 170.3(o)(24)) are considered incidental additives and may be used if removed appropriately. As used herein, the term “artificial” is anything that is not natural, e.g., anything that is made by man.

The sweetener(s) used in the beverage products disclosed here are edible consumables suitable for consumption in beverages. By “edible consumables” is meant a food or beverage or an ingredient of a food or beverage for human or animal consumption. The sweetener or sweetening agent, as those terms are used here, can be a nutritive or non-nutritive, natural or artificial beverage product ingredient or additive (or mixtures of them) which is capable of providing sweetness to the beverage product when used in sweetening amounts. The perception of flavoring agents and sweetening agents may depend to some extent on the interrelation of elements. Flavor and sweetness may also be perceived separately, i.e., flavor and sweetness perception may be both dependent upon each other and independent of each other. For example, when a large amount of a flavoring agent is used, a small amount of a sweetening agent may be readily perceptible and vice versa. Thus, the oral and olfactory interaction between a flavoring agent and a sweetening agent in any given product may involve the interrelationship of elements.

In certain exemplary embodiments, the potent natural sweetener monatin is included in a non-sweetening amount in the beverage products disclosed here. Monatin is otherwise known as 2-hydroxy-2-(indol-3-lymethyl)-4-aminoglutaric acid or 4-hydroxy-4-(3-indolylmethyl) glutamic acid; see formula below. Monatin can be obtained by extraction from the plant Sclerochiton ilicifolius, especially from the bark and the roots. Monatin can also be produced biosynthetically either in vivo or in vitro. Monatin has a sweetness potency of about 2000 times as sweet as sugar (i.e., sucrose), and is a non-nutritive sweetener. Monatin has four stereoisomers: 2R,4R-monatin, 2S,4S-monatin, 2R,4S-monatin, and 2S,4R-monatin. As used herein, the term “monatin” refers to any one or any combination of more than one of these four stereoisomers.

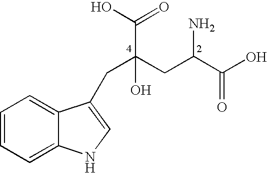

In certain exemplary embodiments, beverage products may include, in addition to the non-sweetening amount of the potent natural sweetener monatin, a sweetening amount of one or more additional natural or artificial sweeteners. As used herein, the term “sweetening amount” refers to an amount of a sweetener that, in a beverage product as a whole, is perceptible as sweet as judged by a majority of persons that have tasted and compared a sample of the beverage product containing the sweetening amount of sweetener to a sample of a correspondingly formulated beverage product without the sweetening amount of sweetener. A sweetening amount of a sweetener, when given a numerical value, can be determined on the basis of the sweetness of a 7% by weight aqueous solution of sucrose. This technique is well known to those skilled in the art and is seen, for example, in U.S. Pat. No. 4,902,525. Sweeteners also can affect the mouthfeel, i.e., the body or texture of the beverage. Too much sweetener can overpower other flavors while too little can yield in some cases a beverage that tastes watery or flat.

Sweeteners other than monatin suitable for use in sweetening amounts in various embodiments of the beverage products disclosed here comprising a non-sweetening amount of the potent natural sweetener monatin include a sweetening amount of natural (e.g., additional natural) and artificial or synthetic sweeteners. Sweetening amounts of suitable sweeteners and combinations of sweeteners are selected for the desired nutritional characteristics, taste profile for the beverage product, sweetness and other organoleptic factors. Natural sweeteners suitable for at least certain such exemplary embodiments include a sweetening amount of, for example, one or more of sorbitol, mannitol, xylitol, D-tagatose, erythritol, maltitol, maltose, lactose, fructo-oligosaccharides, rebaudioside A, stevioside, Lo Han Guo, mogroside V, glycyrrhizin, brazzein, xylitol, xylose, arabinose, isomalt, lactitol, maltitol, trehalose, ribose, protein sweeteners, such as, for example, thaumatin, monellin, L-alanine and glycine, and any combination thereof. Certain exemplary embodiments of the beverage products disclosed herein include a sweetening amount of at least one additional potent natural sweetener, which is different from the potent natural sweetener monatin included in a non-sweetening amount. For example, certain embodiments may include a non-sweetening amount of monatin and a sweetening amount of rebaudioside A. In another example, certain embodiments may include a non-sweetening amount of monatin and a sweetening amount of Lo Han Guo.

In certain exemplary embodiments, the sweetening amount of a potent natural sweetener in the beverage products disclosed here may be, for example, the potent non-nutritive sweetener rebaudioside A, which can be obtained by extraction or purification from the Stevia plant. Stevia (e.g., Stevia rebaudiana Bertoni) is a sweet-tasting plant, whose leaves contain a complex mixture of natural sweet diterpene glycosides (e.g., steviol glycosides). Stevioside and rebaudiosides are components of Stevia that contribute sweetness. Typically, these compounds are found to include stevioside (4-13% dry weight), steviolbioside (trace), the rebaudiosides, including rebaudioside A (2-6%), rebaudioside B (trace), rebaudioside C (1-2%), rebaudioside D (trace), and rebaudioside E (trace), and dulcoside A (0.4-0.7%). Such compounds are referred to herein as Stevia components.

In certain exemplary embodiments, the sweetening amount of a potent natural sweetener in the beverage products disclosed here may be, for example, the non-nutritive, potent sweetener Lo Han Guo. Lo Han Guo has various different spellings and pronunciations, can be obtained from fruit of the plant family Cucurbitaceae, tribe Jollifieae, subtribe Thladianthinae, genus Siraitia. Lo Han Guo often is obtained from the genus/species S. grosvenorii, S. siamensis, S. silomaradjae, S. sikkimensis, S. africana, S. borneensis, and S. taiwaniana. Suitable fruit includes that of the genus/species S. grosvenorii, which is often called Lo Han Guo fruit. Lo Han Guo can be produced, for example, as discussed in U.S. Pat. No. 5,411,755. Lo Han Guo contains triterpene glycosides or mogrosides (e.g., mogroside V), which constituents may be used as Lo Han Guo sweeteners. Lo Han Guo can be used as the juice or juice concentrate, powder, etc. In certain exemplary embodiments, Lo Han Guo juice contains at least about 0.1% mogrosides (e.g., from 0.1% to about 15%) such as mogroside V, mogroside IV, 11-oxo-mogroside V, siamenoside and mixtures thereof. In certain exemplary embodiments, Lo Han Guo juice concentrate contains at least about 2.0% by weight mogroside V. In certain exemplary embodiments, Lo Han Guo powder contains at least about 45% by weight mogroside V.

Sweeteners from other fruits, vegetables or plants also may be used in a sweetening amount as natural or processed sweeteners in at least certain exemplary embodiments of the beverage products disclosed here comprising a non-sweetening amount of a potent natural sweetener.

In certain exemplary embodiments, beverage products having a non-sweetening amount of the potent natural sweetener rebaudioside A also include a sweetening amount of nutritive, natural crystalline or liquid sweeteners, such as a sweetening amount of, for example, sucrose, fructose, glucose, glucose-fructose syrup from natural sources such as apple, chicory, honey, etc., e.g., high fructose corn syrup, invert sugar, maple syrup, maple sugar, honey, brown sugar molasses, e.g., cane molasses, such as first molasses, second molasses, blackstrap molasses, and sugar beet molasses, sorghum syrup, and/or others, and mixtures of any of them.

Exemplary artificial sweeteners suitable for use in a sweetening amount as an optional additional sweetener in at least certain embodiments of the beverage products disclosed here include a sweetening amount of artificial potent sweeteners. Such artificial potent sweeteners include peptide based sweeteners, for example, aspartame, neotame, and alitame, and non-peptide based sweeteners, for example, sodium saccharin, calcium saccharin, acesulfame potassium, sodium cyclamate, calcium cyclamate, neohesperidin dihydrochalcone, sucralose, and mixtures of any of them. It will be within the ability of those skilled in the art, given the benefit of this disclosure, to select suitable additional or alternative sweeteners for use in a sweetening amount in various embodiments of the beverage products comprising a non-sweetening amount of the potent natural sweetener monatin disclosed here.

In certain exemplary embodiments, additional beverage ingredients may be added, including but not limited to acidulants, colorants, flavorants, minerals, vitamins, fruit juices, fruit flavors, or other fruit products, other taste modifiers, e.g., tastents, masking agents and the like, flavor enhancers, and/or carbonation, any of which typically can be added to beverage product formulations to vary the taste, mouthfeel, nutritional characteristics, etc. Exemplary flavorants which may be suitable for at least certain beverage product formulations in accordance with this disclosure include cola flavor, tea flavor, citrus flavor, berry flavor, spice flavor and others. Carbonation in the form of carbon dioxide may be added for effervescence. Preservatives can be added if desired, depending upon the other ingredients, production technique, desired shelf life, etc. Optionally, caffeine can be added.

The beverage products disclosed here include beverages, i.e., ready-to-drink liquid formulations, beverage concentrates and the like. Beverages include, e.g., carbonated soft drinks (e.g., cola beverages, citrus beverages, ginger ale, root beer, flavored seltzer water), non-carbonated soft drinks, fountain beverages, frozen ready-to-drink beverages, coffee beverages, tea beverages, dairy beverages, powdered beverage concentrates as well as liquid beverage concentrates, flavored waters, enhanced waters (e.g. Propel™ fitness water), fruit juice and fruit juice-flavored drinks, sport drinks, energy drinks, hydration drinks (e.g., GATORADE™), health and wellness drinks and alcoholic beverages. Beverages further include, e.g., full calorie drinks/beverages and reduced-calorie (e.g., light, diet, zero calorie) drinks/beverages. Certain exemplary embodiments of the beverage products comprising a non-sweetening amount of the potent natural sweetener monatin disclosed here are cola beverages comprising water (preferably carbonated water), a sweetening amount of at least one sweetener other than monatin, kola nut extract and/or other cola flavorings, caramel color, an acidulant, e.g. phosphoric acid, citric acid, ascorbic acid, lactic acid, tartaric acid, and/or malic acid, and optionally other ingredients. Certain exemplary embodiments of the beverage products comprising a non-sweetening amount of the potent natural sweetener monatin disclosed here are tea beverages comprising water, a sweetening amount of at least one sweetener other than monatin, at least one of a tea extract and a tea flavor, an acidulant, e.g. phosphoric acid, citric acid, ascorbic acid, lactic acid, tartaric acid, and/or malic acid, and optionally other ingredients. Additional and alternative suitable ingredients will be recognized by those skilled in the art given the benefit of this disclosure.

The terms “beverage concentrate” and “syrup” are used interchangeably throughout this disclosure. Alternatively, a beverage concentrate may be in powdered form. At least certain exemplary embodiments of the beverage concentrates contemplated are prepared with an initial volume of water to which the additional ingredients are added. Full strength beverage compositions can be formed from the beverage concentrate by adding further volumes of water to the concentrate such that the concentrate is diluted to a full strength beverage. Typically, for example, full strength beverages can be prepared from the concentrates by combining approximately 1 part concentrate with between approximately 3 to approximately 7 parts water. In certain exemplary embodiments the full strength beverage is prepared by combining 1 part concentrate with 5 parts water. In certain exemplary embodiments the additional water used to form the full strength beverages is carbonated water. In certain other embodiments, a full strength beverage is directly prepared without the formation of a concentrate and subsequent dilution.

Those of ordinary skill in the art will understand that, for convenience, some ingredients are described here in certain cases by reference to the original form of the ingredient in which it is used in formulating or producing the beverage product. Such original form of the ingredient may differ from the form in which the ingredient is found in the finished beverage product. Thus, for example, in certain exemplary embodiments of the beverage products according to this disclosure, a non-sweetening amount of the potent sweetener monatin would typically be substantially homogenously dissolved and dispersed in the beverage. Likewise, other ingredients identified as a solid, a concentrate (e.g., juice concentrate), etc. would typically be homogenously dispersed throughout the beverage or throughout the beverage concentrate, rather than remaining in their original form. Thus, reference to the form of an ingredient of a beverage product formulation should not be taken as a limitation on the form of the ingredient in the beverage product, but rather as a convenient means of describing the ingredient as an isolated component of the product formulation.

Water is a basic ingredient in the beverage products disclosed here comprising a non-sweetening amount the potent natural sweetener monatin, typically being the vehicle or liquid portion in which the remaining ingredients are dissolved, emulsified, suspended or dispersed. Purified water can be used in the manufacture of certain embodiments of the beverage product, and water of a standard beverage quality can be employed in order not to adversely affect beverage taste, odor, or appearance. The water typically will be clear, colorless, free from objectionable minerals, tastes and odors, free from organic matter, low in alkalinity and of acceptable microbiological quality based on industry and government standards applicable at the time of producing the beverage. In certain exemplary embodiments, water is present at a level of from about 80% to about 99.9% by weight of the full strength beverage. In at least certain exemplary embodiments the water used in beverages and concentrates disclosed here is “treated water,” which refers to water that has been treated to remove substantially all mineral content of the water prior to optional supplementation with any of the components described herein as disclosed in U.S. Pat. No. 7,052,725. Methods of producing treated water are known to those of ordinary skill in the art and include deionization, distillation, filtration and reverse osmosis (“R—O”), among others. The terms “treated water,” “purified water,” “demineralized water,” “distilled water,” and “R—O water” are understood to be generally synonymous in this discussion, referring to water from which substantially all mineral content has been removed, typically containing no more than about 500 ppm total dissolved solids, e.g., no more than about 250 ppm.

Certain embodiments of the beverage products disclosed here comprising a non-sweetening amount of the potent natural sweetener monatin also include one or more acids. An acidulant can serve any of one or more functions, including, for example, lending tartness to the taste of the beverage, enhancing palatability, increasing thirst quenching effect, modifying sweetness and acting as a mild preservative. Suitable acids are known and will be apparent to those skilled in the art given the benefit of this disclosure. Exemplary acids suitable for use in some or all embodiments of the beverages comprising a non-sweetening amount of the potent natural sweetener monatin disclosed here include phosphoric acid, citric acid, malic acid, tartaric acid, lactic acid, ascorbic acid, fumaric acid, gluconic acid, succinic acid, maleic acid and adipic acid and mixtures of any of them.

The acid can be used in solution form, for example, and in an amount sufficient to provide the desired pH of the beverage. Typically, for example, the one or more acids of the acidulant are used in amount, collectively, of from about 0.01% to about 0.5% by weight of the beverage, e.g., from about 0.05% to about 0.25% by weight of the beverage, depending upon the acidulant used, desired pH, other ingredients used, etc. The pH of at least certain exemplary embodiments of the beverages disclosed here comprising at least a non-sweetening amount of the potent natural sweetener monatin can be a value within the range of from about 2.0 to about 5.0. The acid in certain exemplary embodiments enhances beverage flavor. Too much acid can impair the beverage flavor and result in sourness or other off-taste, while too little acid can make the beverage taste flat.

The particular acid or acids chosen and the amount used will depend, in part, on the other ingredients, the desired shelf life of the beverage product, as well as effects on the beverage pH, titratable acidity, and taste. Those skilled in the art, given the benefit of this disclosure, will recognize that when preparing beverage products containing peptide-based artificial sweeteners such as aspartame, the resulting beverage composition is best maintained below a certain pH to retain the sweetening effect of the artificial sweetener. In the formation of calcium-supplemented beverages, the presence of calcium salts increases the pH which requires additional acids to both assist the dissolution of the salt and maintain a desirable pH for stability of the artificial sweetener. The presence of the additional acid in the beverage composition, which increases the titratable acidity of the composition, will result in a more tart or sour taste to the resulting beverage. It will be within the ability of those skilled in the art, given the benefit of this disclosure, to select a suitable acid or combination of acids and the amounts of such acids for the acidulant component of any particular embodiment of the beverages comprising a non-sweetening amount of the potent natural sweetener monatin disclosed here.

Certain exemplary embodiments of the beverage products disclosed here comprising a non-sweetening amount of the potent natural sweetener monatin also may contain small amounts of alkaline agents to adjust pH. Such agents include, e.g., potassium hydroxide, sodium hydroxide, calcium hydroxide, and potassium carbonate. For example, the alkaline agent potassium hydroxide may be used in an amount of from about 0.02 to about 0.04% by weight, with an amount of about 0.03% being typical for certain beverages. The amount will depend on the type of alkaline agents and on the degree to which the pH is to be adjusted.

The beverage products and flavor systems disclosed here comprising a non-sweetening amount of the potent natural sweetener monatin optionally contain one or more additional flavor compositions, for example, natural and synthetic fruit flavors, botanical flavors, other flavors, and mixtures thereof. As used here, the term “fruit flavor” refers generally to those flavors derived from the edible reproductive part of a seed plant. Included are both those wherein a sweet pulp is associated with the seed, e.g., banana, tomato, cranberry and the like, and those having a small, fleshy berry. Also included within the term “fruit flavor” are synthetically prepared flavors made to simulate fruit flavors derived from natural sources. Examples of suitable fruit sources include whole fruits or portions thereof, fruit juice, fruit juice concentrates, fruit purees and blends thereof, dried fruit powders, dried fruit juice powders, freeze dried fruit juices, powders and purees and the like.

Exemplary fruit flavors include the citrus flavors, e.g., orange, mandarin orange, tangerine, tangelo, pomelo, lemon, lime and grapefruit, and such flavors as apple, grape, cherry, and pineapple flavors and the like, and any combination thereof. In certain exemplary embodiments the beverage concentrates, beverages, and flavor systems comprise a fruit flavor component, e.g., a juice concentrate or juice. As used here, the term “botanical flavor” refers to flavors derived from parts of a plant other than the fruit. As such, botanical flavors can include those flavors derived from essential oils and extracts of nuts, bark, roots and leaves. Also included within the term “botanical flavor” are synthetically prepared flavors made to simulate botanical flavors derived from natural sources. Examples of such botanical flavors include cola flavors, tea flavors, coffee, cocoa, hazelnut, almond, other nut flavors, and mixtures thereof. The flavor component can further comprise a blend of various of the above-mentioned flavors. In certain exemplary embodiments of the beverage concentrates, beverages, and flavor systems described here, a cola flavor component and/or a tea flavor component is used. The particular amount of the flavor component useful for imparting flavor characteristics to the beverages comprising a non-sweetening amount of a potent natural sweetener disclosed here will depend upon the flavor(s) selected, the flavor impression desired, and the form of the flavor component. Those skilled in the art, given the benefit of this disclosure, will be readily able to determine the amount of any particular flavor component(s) used to achieve the desired flavor impression.

In certain exemplary embodiments, the beverage products and flavor systems comprising a non-sweetening amount of the potent natural sweetener monatin disclosed here can be provided in the form of juice. Juices can be employed in the form of a concentrate, puree, single-strength juice, or other suitable forms. The term “juice” as used here includes single-strength fruit and/or or vegetable juice, as well as concentrates, purees, milks, and other forms. Multiple different fruit and/or vegetable juices can be combined, optionally along with other flavorings, to generate a beverage having the desired flavor. Examples of suitable juice sources include, but are not limited to, plum, prune, fig, pineapple, peach, banana, apple, pear, guava, apricot, coconut, olive, kiwi, quince, buckthorn, passion fruit, rowan, pomegranate, persimmon, mango, rhubarb, papaya, litchi, lemon, orange, lime, tangerine, mandarin orange, tangelo, pomelo, grapefruit, Barbados cherry (acerola cherry), bearberry, blackberry, blueberry, boysenberry, cherry, choke cherry, cloudberry, cranberry, current, date, dewberry, elderberry, grape, gooseberry, huckleberry, loganberry, olallieberry, mulberry, raisin, plains berry, prairie berry, raspberry, Saskatoon berry, salmonberry, Seabuckthorn berry, sloe berry, strawberry, thimbleberry, Thomberry, wineberry, whortleberry and the like. Numerous additional and alternative juices suitable for use in at least certain exemplary embodiments will be apparent to those skilled in the art given the benefit of this disclosure. In beverage products disclosed here employing juice, juice may be used, for example, at a level of at least about 0.2% by weight of the beverage. In certain exemplary embodiments juice is employed at a level of from about 0.2% to about 40% by weight of the beverage. Typically, juice can be used, if at all, in an amount of from about 1% to about 20% by weight.

Certain such juices which are lighter in color can be included in the formulation of certain exemplary embodiments to adjust the flavor and/or increase the juice content of the beverage without darkening the beverage color. Examples of such juices include apple, pear, pineapple, peach, lemon, lime, orange, mandarin orange, tangelo, pomelo, apricot, grapefruit, tangerine, rhubarb, cassis, quince, passion fruit, papaya, mango, guava, litchi, kiwi, mandarin, coconut, and banana. Deflavored and decolored juices can be employed if desired.

Other flavorings suitable for use in at least certain exemplary embodiments of the beverage products and flavor systems disclosed here include, e.g., spice flavorings, such as cassia, clove, cinnamon, pepper, ginger, vanilla spice flavorings, cardamom, coriander, root beer, sassafras, ginseng, and others. Numerous additional and alternative flavorings suitable for use in at least certain exemplary embodiments will be apparent to those skilled in the art given the benefit of this disclosure. Flavorings can be in the form of an extract, oleoresin, juice concentrate, bottler's base, or other forms known in the art. In at least certain exemplary embodiments, such spice or other flavors complement that of a juice or juice combination.

The one or more flavorings can be used in the form of an emulsion. A flavoring emulsion can be prepared by mixing some or all of the flavorings together, optionally together with other ingredients of the beverage, and an emulsifying agent. The emulsifying agent may be added with or after the flavorings mixed together. In certain exemplary embodiments the emulsifying agent is water-soluble. Exemplary suitable emulsifying agents include gum acacia, modified starch, carboxymethylcellulose, gum tragacanth, gum ghatti and other suitable gums. Additional suitable emulsifying agents will be apparent to those skilled in the art of beverage formulations, given the benefit of this disclosure. The emulsifier in exemplary embodiments comprises greater than about 3% of the mixture of flavorings and emulsifier. In certain exemplary embodiments the emulsifier is from about 5% to about 30% of the mixture.

Weighting agents, which can also act as clouding agents, are typically used to keep the emulsion droplets dispersed in the beverage. Examples of such weighting agents are brominated vegetable oils, rosin esters and, in particular, ester gums. Any weighting agent that is commercially available can be used in beverages comprising at least a non-sweetening amount of the potent natural sweetener monatin disclosed here. Besides weighting agents, emulsifiers and emulsion stabilizers can be used to stabilize the flavor emulsion droplets. Examples of such emulsifiers and emulsion stabilizers include gums, pectins, cellulose, polysorbates, sorbitan esters and propylene glycol alginates.

Carbon dioxide is used to provide effervescence to certain exemplary embodiments of the beverage products disclosed here. Any of the techniques and carbonating equipment known in the art for carbonating beverages can be employed. Carbon dioxide can enhance the beverage taste and appearance and can aid in safeguarding the beverage purity by inhibiting and destroying objectionable bacteria. In certain embodiments, for example, the beverage has a CO₂ level up to about 7.0 volumes carbon dioxide. Typical embodiments may have, for example, from about 0.5 to 5.0 volumes of carbon dioxide. As used here and independent claims, one volume of carbon dioxide is defined as the amount of carbon dioxide absorbed by any given quantity of water at 60° F. (16° C.) temperature and atmospheric pressure. A volume of gas occupies the same space as does the water by which it is absorbed. The carbon dioxide content can be selected by those skilled in the art based on the desired level of effervescence and the impact of the carbon dioxide on the taste or mouthfeel of the beverage. The carbonation can be natural or synthetic.

Optionally, caffeine can be added to various embodiments of the beverage products comprising a non-sweetening amount of the potent natural sweetener monatin disclosed here. The amount of caffeine added is determined by the desired beverage properties, any applicable regulatory provisions of the country where the beverage is to be marketed, etc. The caffeine must be of a purity acceptable for use in foods and beverages. The caffeine can be natural (e.g., from kola, cocoa nuts, coffee and/or tea) or synthetic in origin. If caffeine is present in the formulation prior to adding additional caffeine (e.g., in coffee or tea beverages), the caffeine present in them should be factored into the percentage of caffeine in the beverage. The amount of caffeine can be from about 0.002% to about 0.05% by weight of the single strength beverage. In certain embodiments, the amount of caffeine is from about 0.005% to about 0.02%. In certain exemplary embodiments caffeine is included at a level of 0.02 percent or less by weight of the beverage. For concentrates or syrups, the caffeine level can be from about 0.006% to about 0.15%. Caffeine levels can be higher, for example, if flavored coffees which have not been decaffeinated are used since these materials contain caffeine naturally.

The beverage products disclosed here may contain additional ingredients, including, generally, any of those typically found in beverage formulations. These additional ingredients, for example, can typically be added to a stabilized beverage concentrate. Examples of such additional ingredients include, but are not limited to, those disclose herein, such as caffeine, caramel and other coloring agents or dyes, antifoaming agents, gums, emulsifiers, tea solids, tea extracts, cloud components, and nutritional supplements.

Examples of nutritional supplement ingredients are known to those of ordinary skill in the art and include, without limitation, vitamins, minerals, herbs or botanicals, amino acids, or essential fatty acids or enzymes, proteases, tissues, organs, glands or portions thereof. Vitamins include, but are not limited to, vitamin A, vitamin D, vitamin E (tocopherol), vitamin C (ascorbic acid), vitamin B₁ (thiamine), vitamin B₂ (riboflavin), vitamin B₃ (niacin), vitamin B₅ (pantothenic acid), vitamin B₆ (pyridoxine), vitamin B₇ (biotin), vitamin B₉ (folic acid), vitamin B₁₂ (cyanocobalamin), vitamin K (naphthoquinone), vitamin D (D₁ (molecular compound of ergocalciferol with lumisterol, 1:1); D₂ (ergocalciferol or calciferol); D₃ (cholecalciferol); D₄ (dihydrotachysterol); D₅ (sitocalciferol)), and combinations thereof. Supplements are typically present in amounts generally accepted under good manufacturing practices and are typically present in amounts between about 1% to about 100% RDV, where such RDV are established. In certain embodiments, the nutritional supplement ingredient(s) may be present in an amount of from about 5% to about 20% RDV, where established.

Beverage products comprising a non-sweetening amount of the potent natural sweetener monatin disclosed here can optionally further include one or more colorants. As used herein, the “colorant” is intended to mean any compound that imparts color, which includes, but is not limited to natural pigments, synthetic pigment, color additives and mixtures thereof. Natural and artificial colors may be used. One or more FD&C dyes (e.g., yellow #5, blue #2, red #40) and/or FD&C lakes can be used to color beverages comprising a non-sweetening amount of a potent natural sweetener disclosed here. Exemplary lake dyes which may be used in beverages comprising at least a non-sweetening amount of a potent natural sweetener disclosed here are the FDA-approved Lake, such as Lake red #40, yellow #6, blue #1, and the like. Additionally, a mixture of FD&C dyes or a FD&C lake dye in combination with other conventional food and food colorants may be used. Other coloring agents, for example, natural agents may be utilized. Non-limiting examples of such other coloring agents include fruit and vegetable juices and/or powders, caramel color, riboflavin, carotenoids (for example, beta-carotene), tumeric, and lycopenes. The exact amount of coloring agent used will vary, depending on the agents used and the intensity desired in the finished product. Generally, if utilized, the coloring agent should be present at a level of from about 0.0001% to about 0.5%, from about 0.001% to about 0.1%, or from about 0.004% to about 0.1%, by weight or volume of the composition.

Preservatives may be used in at least certain embodiments of the beverage products disclosed here comprising a non-sweetening amount of the potent natural sweetener monatin. That is, at least certain exemplary embodiments contain an optional dissolved preservative system. Solutions with a pH below 4 and especially those below 3 typically are “microstable,” i.e., they resist growth of microorganisms, and so are suitable for longer term storage prior to consumption without the need for further preservatives. However, an additional preservative system can be used if desired. If a preservative system is used, it can be added to the beverage product at any suitable time during production, e.g., in some cases prior to the addition of the sweetener. As used here, the terms “preservation system” or “preservatives” include all suitable preservatives approved for use in food and beverage compositions, including, without limitation, such known chemical preservatives as benzoates, e.g., sodium, calcium, and potassium benzoate, sorbates, e.g., sodium, calcium, and potassium sorbate, citrates, e.g., sodium citrate and potassium citrate, polyphosphates, e.g., sodium hexametaphosphate (SHMP), and mixtures thereof, and antioxidants such as ascorbic acid, EDTA, BHA, BHT, TBHQ, dehydroacetic acid, dimethyldicarbonate, ethoxyquin, heptylparaben, and any combination thereof.

Preservatives can be used in amounts not exceeding mandated maximum levels under applicable laws and regulations. The level of preservative used typically is adjusted according to the planned final product pH, as well as an evaluation of the microbiological spoilage potential of the particular beverage formulation. The maximum level employed typically is about 0.05% by weight of the beverage. It will be within the ability of those skilled in the art, given the benefit of this disclosure, to select a suitable preservative or combination of preservatives for beverages according to this disclosure.

Other methods of beverage preservation suitable for at least certain exemplary embodiments of the beverage products disclosed here include, e.g., heat treatment or thermal processing steps, such as hot filling and tunnel pasteurization. Such steps can be used to reduce yeast, mold and microbial growth in the beverage products. For example, U.S. Pat. No. 4,830,862 to Braun et al. discloses the use of pasteurization in the production of fruit juice beverages as well as the use of suitable preservatives in carbonated beverages. U.S. Pat. No. 4,925,686 to Kastin discloses a heat-pasteurized freezable fruit juice composition which contains sodium benzoate and potassium sorbate.

In accordance with another aspect of the invention, a flavor system is provided including a non-sweetening amount of the potent natural sweetener monatin, a solvent, and at least one of a flavor extract and an aroma chemical. In certain exemplary embodiments, the flavor system comprises monatin in an amount which is non-sweetening in a full strength beverage and results in greater than zero and less than 3.0 ppm (e.g., 0.1 ppm to 2.5 ppm, 1.0 ppm to 2.0 ppm, greater than zero and less than 1.0 ppm, 0.2 ppm to 0.5 ppm, greater than zero and less than 0.2 ppm) of monatin in the full strength beverage after the flavor system has been incorporated into the full strength beverage in an amount between about 0.01% to about 5.0% (e.g. about 0.2% to about 3.5%, about 0.35% to about 0.5%) by weight of the full strength beverage.

In certain exemplary embodiments, the solvent may include water, ethanol, glycerin, propylene glycol, benzyl alcohol, isopropanol, triacetin, and mixtures of any of them. In certain exemplary embodiments, the flavor extract may include fruit extracts, botanical extracts, spice extracts, and mixtures of any of them. Exemplary fruit extracts include citrus extracts (e.g., extracts of orange, mandarin orange, tangerine, tangelo, pomelo, lemon, lime, and grapefruit, among others), berry extracts (e.g., extracts of blackberry, blueberry, boysenberry, cranberry, raspberry, and strawberry, among others), and extracts of apple, grape, cherry, pineapple, plum, prune, fig, pineapple, peach, banana, pear, guava, apricot, coconut, olive, kiwi, quince, passion fruit, pomegranate, persimmon, mango, rhubarb, papaya, lychee, currant, and date. Exemplary botanical extracts include extracts of kola nut, tea, coffee, cocoa, hazelnut, almond, and others. Exemplary spice extracts include extracts of cassia, clove, cinnamon, pepper, ginger, vanilla, cardamom, coriander, root beer, sassafras, ginseng, and others.

In certain exemplary embodiments, the aroma chemical may include any chemical that provides an olfactory organoleptic effect, and is designated by the Flavor and Extract Manufacturers' Association (FEMA) to be Generally Recognized As Safe (GRAS). A chemical designated as GRAS by FEMA has been tested using certain standards and deemed safe for use by humans. Exemplary GRAS aroma chemicals include acetic aldehyde, acetic acid, Isoamyl acetate, 3-methylbutanol, isoamyl butyrate, isoamyl hexanoate, isoamyl isovalerate, benzaldehyde, benzoic acid, benzyl acetate, benzyl alcohol, benzyl cinnamate, butyl acetate, isobutyl acetate, butanol, isobutanol, butyl butyrate, isobutyl butyrate, butyl isobutyrate, butyl hexanoate, isobutyl propionate, butyraldehyde, isobutyraldehyde, butyric acid, isobutyric acid, cinnamaldehyde, cinnamic acid, 2,3-butanedione, ethyl acetate, ethyl acetoacetate, ethyl benzoylacetate, ethyl butyrate, ethyl isobutyrate, ethyl cinnamate, ethyl heptanoate, ethyl hexanoate, ethyl lactate, ethyl 2-methylbutyrate, ethyl propionate, ethyl pyruvate, ethyl valerate, ethyl isovalerate, 2-heptanone, hexanal, hexanoic acid, hexanol, raspberry ketone, α-ionone, β-ionone, lactic acid, 2-methylbutyraldehyde, isovaleraldehyde, 2-methylbutyric acid, methyl cinnamate, methyl 2-methylbutyrate, methyl propionate, propionaldehyde, propanoic acid, propanol, pyruvic acid, valeric acid, isovaleric acid, vanillin, 4-methyl-5-hydroxyethyl thiazole, acetone, heptanoic acid, 2-methylbutyl 2-methylbutyrate, 2-isopropyl-5-methyl-2-hexenal, ethyl 3-hydroxybutyrate, 2-methylbutyl isovalerate, isoamyl isobutyrate, tiglic acid, D-2-methylbutyl acetate, L-2-methylbutanol, methanol, cyclopentadecanone, acetic anhydride, and other compounds. GRAS aroma chemicals may be extracted from natural sources or produced synthetically.

The following examples are specific embodiments of the present invention, but are not intended to limit it.

### EXAMPLE 1

A flavor solution of 0.01 wt. % (100 ppm) monatin in water, optionally a mixture of water and other solvents, is prepared. To form a beverage, the flavor solution in an amount greater than zero and less than 3.0 wt. % based on the total weight of the beverage (e.g., 0.1-2.5 wt. %, 1.0-2.0 wt. %) is mixed with other beverage ingredients, e.g., one or more of a sweetening amount of sweetener, an acidulant, another flavorant, a colorant, additional water, and any other beverage ingredient. The beverage may be a carbonated beverage, a non-carbonated beverage, or any other beverage product. The beverage comprising a non-sweetening amount of monatin (e.g., greater than zero and less than 3.0 ppm, 0.1 ppm to 2.5 ppm, 1.0 ppm to 2.0 ppm, greater than zero and less than 1.0 ppm, 0.2 ppm to 0.5 ppm, greater than zero and less than 0.2 ppm) exhibits at least one increased desirable taste characteristic (e.g., increased flavor impact, flavor enhancement, improved mouthfeel, improved sweetness temporal effect) and/or at least one reduced or eliminated undesirable taste characteristic (e.g., reduced off-notes, reduced aftertaste, reduced sweetness linger) compared with a corresponding beverage formulation that does not include the non-sweetening amount of monatin.

### EXAMPLE 2

A flavor solution of 1.0 wt. % (10,000 ppm) monatin in water, optionally a mixture of water and other solvents, is prepared. To form a beverage, the flavor solution in an amount greater than zero and less than 0.03 wt. % based on the total weight of the beverage (e.g., 0.001-0.025 wt. %, 0.01-0.02 wt. %) is mixed with other beverage ingredients, e.g., one or more of a sweetening amount of sweetener, an acidulant, another flavorant, a colorant, additional water, and any other beverage ingredient. The beverage may be a carbonated beverage, a non-carbonated beverage, or any other beverage product. The beverage comprising a non-sweetening amount of monatin (e.g., greater than zero and less than 3.0 ppm, 0.1 ppm to 2.5 ppm, 1.0 ppm to 2.0 ppm, greater than zero and less than 1.0 ppm, 0.2 ppm to 0.5 ppm, greater than zero and less than 0.2 ppm) exhibits at least one increased desirable taste characteristic (e.g., increased flavor impact, flavor enhancement, improved mouthfeel, improved sweetness temporal effect) and/or at least one reduced or eliminated undesirable taste characteristic (e.g., reduced off-notes, reduced aftertaste, reduced sweetness linger) compared with a corresponding beverage formulation that does not include the non-sweetening amount of monatin.

### EXAMPLE 3

A citrus flavor system is prepared by mixing together the ingredients below in amounts within the disclosed ranges so that the total amount of citrus flavor ingredients is 100 wt. %. All percentages for the citrus flavor ingredients are weight percentages based on the total weight of the citrus flavor system.
Citrus extract=40-80 wt. %
Aroma chemical=0.10-2.0 wt. %
Monatin=0.01-1.0 wt. %
Water=5.0-20 wt. %
Solvent (ethanol)=10-30 wt. %

To form a beverage, the citrus flavor system in an amount greater than zero and less than 3.0 wt. % (e.g., 0.01-2.5 wt. %, 0.50-1.8 wt. %), based on the total weight of the beverage is mixed with other beverage ingredients, e.g., one or more of a sweetening amount of sweetener, an acidulant, a colorant, additional water, and any other beverage ingredient. The beverage may be a carbonated beverage, a non-carbonated beverage, or any other beverage product. The citrus-flavored beverage comprising a non-sweetening amount of monatin (e.g., greater than zero and less than 3.0 ppm, 0.1 ppm to 2.5 ppm, 1.0 ppm to 2.0 ppm) exhibits at least one increased desirable taste characteristic (e.g., increased flavor impact, flavor enhancement, improved mouthfeel, improved sweetness temporal effect) and/or at least one reduced or eliminated undesirable taste characteristic (e.g., reduced off-notes, reduced aftertaste, reduced sweetness linger) compared with a corresponding citrus-flavored beverage formulation that does not include the non-sweetening amount of monatin.

### EXAMPLE 4

A cola flavor system is prepared by mixing together the flavor solution of Example 2 in an amount of 0.1-3.0 wt. % and cola flavor in an amount of 97-99.9 wt. % (percentages are weight percentages based on the total weight of the cola flavor system), so that the total amount of cola flavor ingredients is 100 wt. %. To form a beverage, the cola flavor system in an amount of 0.1-3.0 wt. % based on the total weight of the beverage is mixed with other beverage ingredients, e.g. a sweetening amount of sweetener, caramel color, phosphoric acid, caffeine, and carbonated water. The cola-flavored beverage comprising a non-sweetening amount of monatin (e.g., greater than zero and less than 3.0 ppm, 0.1 ppm to 2.5 ppm, 1.0 ppm to 2.0 ppm) exhibits at least one increased desirable taste characteristic (e.g., increased flavor impact, flavor enhancement, improved mouthfeel, improved sweetness temporal effect) and/or at least one reduced or eliminated undesirable taste characteristic (e.g., reduced off-notes, reduced aftertaste, reduced sweetness linger) compared with a corresponding cola beverage formulation that does not include the non-sweetening amount of monatin.

### EXAMPLE 5

Other flavor systems are prepared by mixing the flavor solution of Example 2 in an amount of 0.1-3.0 wt. %, and any fruit flavor, botanical flavor, and/or spice flavor in an amount of 97-99.9 wt. % (percentages are weight percentages based on the total weight of the flavor system), so that the total amount of flavor ingredients is 100 wt. %. To form a beverage, the flavor system in an amount of 0.1-3.0 wt. % based on the total weight of the beverage is mixed with other beverage ingredients, e.g. one or more of a sweetening amount of sweetener, a colorant, an acidulant, a preservative, additional water, or any other beverage ingredients. The beverage may be a carbonated beverage, a non-carbonated beverage, or any other beverage product. The flavored beverage comprising a non-sweetening amount of monatin (e.g., greater than zero and less than 3.0 ppm, 0.1 ppm to 2.5 ppm, 1.0 ppm to 2.0 ppm, greater than zero and less than 1.0 ppm, 0.2 ppm to 0.5 ppm, greater than zero and less than 0.2 ppm) exhibits at least one increased desirable taste characteristic (e.g., increased flavor impact, flavor enhancement, improved mouthfeel, improved sweetness temporal effect) and/or at least one reduced or eliminated undesirable taste characteristic (e.g., reduced off-notes, reduced aftertaste, reduced sweetness linger) compared with a corresponding beverage formulation that does not include the non-sweetening amount of monatin.

The contents of all references, patents and published patent applications cited throughout this application are hereby incorporated by reference in their entirety for all purposes. Given the benefit of the above disclosure and description of exemplary embodiments, it will be apparent to those skilled in the art that numerous alternative and different embodiments are possible in keeping with the general principles of the invention disclosed here. Those skilled in this art will recognize that all such various modifications and alternative embodiments are within the true scope and spirit of the invention. The appended claims are intended to cover all such modifications and alternative embodiments. All disclosed percentages are percent by weight. It should be understood that the use of a singular indefinite or definite article (e.g., “a,” “an,” “the,” etc.) in this disclosure and in the following claims follows the traditional approach in patents of meaning “at least one” unless in a particular instance it is clear from context that the term is intended in that particular instance to mean specifically one and only one. Likewise, the term “comprising” is open ended, not excluding additional items, features, components, etc.

What is claimed is:

1. A beverage product comprising:
water;
a non-sweetening amount of monatin, wherein
the non-sweetening amount of monatin in the beverage product is in the range of greater than zero and less than 3.0 ppm, and
the non-sweetening amount of monatin in the beverage product is effective as a taste modifier; and
an additional beverage product ingredient comprising at least one of:
a sweetening amount of a sweetener other than monatin comprising at least one of a potent natural sweetener other than monatin, a potent artificial sweetener, a nutritive natural sweetener, a non-nutritive natural sweetener other than monatin, and a mixture of any of them;
a flavorant;
a colorant;
an acidulant;
a vitamin;
a mineral;
and a mixture of any of them.

2. The beverage product of claim 1, wherein the beverage product is a full calorie beverage, a diet beverage, a zero calorie beverage, or a low calorie beverage.

3. The beverage of claim 1, wherein the beverage product is a reduced calorie beverage or a light beverage.

4. The beverage product of claim 1, wherein the beverage product is a carbonated soft drink, a non-carbonated soft drink, an energy drink, a hydration drink, a health and wellness drink, a fountain beverage, a frozen ready-to-drink beverage, a coffee beverage, a tea beverage, a dairy beverage, a flavored water, an enhanced water, a fruit juice, a fruit juice-flavored drink, a sport drink, an alcoholic beverage, or a mixture of any of them.

5. The beverage product of claim 4, wherein the carbonated soft drink is a cola beverage, a citrus beverage, a ginger ale, a root beer, or a flavored seltzer water.

6. The beverage product of claim 5, wherein the carbonated soft drink is a cola beverage, wherein the water comprises carbonated water, and wherein the additional beverage product ingredient comprises a sweetening amount of at least one sweetener other than monatin, cola flavor, caramel color, and at least one of phosphoric acid, citric acid, ascorbic acid, lactic acid, tartaric acid, and malic acid.

7. The beverage product of claim 4, wherein the beverage product is a tea beverage wherein the additional beverage product ingredient comprises a sweetening amount of at least one sweetener other than monatin, at least one of a tea flavor and a tea extract, and at least one of phosphoric acid, citric acid, ascorbic acid, lactic acid, tartaric acid, and malic acid.

8. The beverage product of claim 1, wherein the non-sweetening amount of monatin effective as a taste modifier provides one or more of an increase of at least one desirable taste characteristic, a decrease of at least one undesirable taste characteristic, and a decrease of at least one undesirable mouthfeel characteristic.

9. The beverage product of claim 8, wherein the increase of at least one desirable taste characteristic comprises at least one of accentuation of flavor impact, flavor enhancement, improvement of sweetness temporal effect, and addition of quick sweetness onset.

10. The beverage product of claim 8, wherein the decrease of at least one undesirable taste characteristic comprises at least one of reduction of sweetness linger, reduction or masking of off-notes, and reduction of aftertaste.

11. The beverage product of claim 1, wherein the additional potent natural sweetener other than monatin comprises at least one of rebaudioside A, stevioside, Lo Han Guo powder, Lo Han Guo juice concentrate, mogroside V, glycyrrhizin, and a mixture of any of them.

12. The beverage product of claim 1, wherein the potent artificial sweetener comprises at least one of aspartame, acesulfame K, saccharin, cyclamate, neotame, sucralose, neohesperidin dihydrochalcone, alitame, and a mixture of any of them.

13. The beverage product of claim 1, wherein the nutritive natural sweetener comprises at least one of glucose-fructose syrup, sucrose, glucose, fructose, and a mixture of any of them.

14. The beverage product of claim 1, wherein the non-nutritive natural sweetener other than monatin comprises at least one of sorbitol, mannitol, xylitol, D-tagatose, erythritol, maltitol, maltose, lactose, fructo-oligosaccharides, xylose, arabinose, isomalt, lactitol, maltitol, trehalose, ribose, and a mixture of any of them.

15. The beverage product of claim 1, wherein the acidulant comprises at least one of phosphoric acid, citric acid, ascorbic acid, lactic acid, tartaric acid, and malic acid.

16. The beverage product of claim 1, wherein the non-sweetening amount of monatin in the beverage product is in the range of 0.1 ppm to 2.5 ppm.

17. The beverage product of claim 1, wherein the non-sweetening amount of monatin in the beverage product is in the range of 1.0 ppm to 2.0 ppm.

18. The beverage product of claim 1, wherein the non-sweetening amount of monatin in the beverage product is in the range of greater than zero and less than 1.0 ppm.

19. The beverage product of claim 1, wherein the non-sweetening amount of monatin in the beverage product is in the range of 0.2 ppm to 0.5 ppm.

20. The beverage product of claim 1, wherein the non-sweetening amount of monatin in the beverage product is in the range of greater than zero and less than 0.2 ppm.

21. A beverage concentrate comprising:
an initial volume of water;
monatin in an amount which in a full strength beverage produced by dilution of one part concentrate with five parts water,
is non-sweetening,
is greater than zero and less than 3.0 ppm, and
is effective as a taste modifier in the full strength beverage; and
an additional beverage product ingredient comprising at least one of:
a sweetening amount of a sweetener other than monatin comprising at least one of a potent natural sweetener other than monatin, a potent artificial sweetener, a nutritive natural sweetener, a non-nutritive natural sweetener other than monatin, and a mixture of any of them;
a flavorant;
a colorant;
an acidulant;
a vitamin;
a mineral;
and a mixture of any of them.

22. A flavor system for a full strength beverage, comprising
a solvent,
at least one of a flavor extract and an aroma chemical, and
monatin in an amount which is non-sweetening, is effective as a taste modifier, and is present in an amount greater than zero and less than 3.0 ppm in the full strength beverage comprising the flavor system in an amount in the range of 0.01% to 5.0% by weight of the full strength beverage.

23. The flavor system of claim 22,
wherein the solvent comprises at least one of water, ethanol, glycerin, propylene glycol, benzyl alcohol, isopropanol, and triacetin; and
wherein the flavor extract comprises at least one of a cola extract, a tea extract, a berry extract, and a citrus extract.

24. A method for making a full strength beverage comprising the steps of:
providing a flavor system comprising
a solvent,
at least one of a flavor extract and an aroma chemical, and
monatin in an amount which in the full strength beverage comprising the flavor system in an amount in the range of 0.01% to 5.0% by weight of the full strength beverage;
is non-sweetening,
is present in an amount greater than zero and less than 3.0 ppm, and
is effective as a taste modifier,
providing an additional beverage ingredient comprising at least one of:
carbonated water;
non-carbonated water;
a sweetening amount of a sweetener other than monatin comprising at least one of a potent natural sweetener other than monatin, a potent artificial sweetener, a nutritive natural sweetener, a non-nutritive natural sweetener other than monatin, and a mixture of any of them;
a colorant;
an acidulant;
a vitamin;
a mineral;
and a mixture of any of them; and
mixing the flavor system in an amount in the range of 0.01% to 5.0% by weight of the full strength beverage with the additional beverage ingredient to form the full strength beverage.

25. The method of claim 24, wherein
the full strength beverage is a cola beverage,
the flavor extract comprises cola flavor, and
the additional beverage ingredient comprises carbonated water, a sweetening amount of a sweetener other than monatin, caramel color, and at least one of phosphoric acid, citric acid, ascorbic acid, lactic acid, tartaric acid, and malic acid.

26. The method of claim 24, wherein
the full strength beverage is a tea beverage,
the flavor extract comprises tea extract, and
the at least one additional beverage ingredient comprises non-carbonated water, a sweetening amount of at least one sweetener other than monatin, and at least one of phosphoric acid, citric acid, ascorbic acid, lactic acid, tartaric acid, and malic acid.
